(19) United States
(12) Patent Application Publication
(10) Pub. No.: US 2014/0347851 A1
(43) Pub. Date: Nov. 27, 2014

(54) OPTICAL SEMICONDUCTOR LIGHTING APPARATUS

(71) Applicant: POSCO LED COMPANY LTD., Seongnam-si (KR)

(72) Inventors: Jin Jong Kim, Seongnam-si (KR); Kyoung Onn Kim, Seongnam-si (KR); Ji Wan Kim, Seongnam-si (KR)

(21) Appl. No.: 13/920,359

(22) Filed: Jun. 18, 2013

(30) Foreign Application Priority Data
May 22, 2013 (KR) 10-2013-0057599

(51) Int. Cl. F21K 99/00

(52) U.S. Cl. CPC F21K 9/50
USPC 362/235

(57) ABSTRACT

An optical semiconductor lighting apparatus includes a light emitting module including semiconductor optical devices arranged in a plurality of rows and columns, a housing including a heat sink base in which the light emitting module is disposed, and an optical unit arranged in parallel along the plurality of row or column directions and configured to change a path of light emitting from the semiconductor optical devices to a specific direction. The optical unit includes at least one unit module integrally formed in the row or column directions of the semiconductor optical devices.

### CROSS-REFERENCE TO RELATED APPLICATION

This application claims priority from and the benefit of Korean Patent Application No. 10-2013-0057599, filed on May 22, 2013, which is incorporated herein for all purposes as if fully set forth.

### BACKGROUND

1. Field

The present invention relates to an optical semiconductor lighting apparatus, and more particularly, to an optical semiconductor lighting apparatus which can be implemented with a small-sized and compact structure and can freely control light distribution.

2. Discussion of the Background

As compared with incandescent bulbs and fluorescent lamps, optical semiconductors using a light source, such as a light emitting diode (LED), an organic LED, a laser diode, and an organic electroluminescent diode, have low power consumption, long lifespan, superior durability, and high luminance. Due to these advantages, the optical semiconductors have recently attracted attention as an illumination component.

In particular, in a large-sized light source, of which the light emitting surface has a large area, such as a street light or a factory light, a main optical component is a reflection plate. Due to such a refection plate, it is necessary to increase the size of optical components.

Accordingly, as the optical component is smaller in size, separate components for fixing the optical components are additionally required.

In addition, as described above, a conventional reflection plate is provided for controlling a linear light emitting surface based on the characteristics of optical semiconductors, such as an LED having strong light straightness. In the conventional reflection plate, the control efficiency of light distribution is relatively lowered.

Accordingly, there is an urgent need for an apparatus which can be implemented with a small-sized and compact structure and can freely control light distribution.

### SUMMARY

The present invention has been made in an effort to solve the above problems, and provides an optical semiconductor lighting apparatus which can be implemented with a small-sized and compact structure and can freely control light distribution.

According to an embodiment of the present invention, an optical semiconductor lighting apparatus includes: a light emitting module including semiconductor optical devices arranged in a plurality of rows and columns; a housing including a heat sink base in which the light emitting module is disposed; and an optical unit arranged in parallel along the plurality of row or column directions and configured to change a path of light emitting from the semiconductor optical devices to a specific direction, wherein the optical unit includes at least one unit module integrally formed in the row or column directions of the semiconductor optical devices.

The unit module may include: a top surface convexly inclined to be biased toward one side in the column or column directions of the plurality of semiconductor optical devices; and a bottom surface concavely recessed and inclined to be biased toward a direction opposite to a direction of inclination of the top surface.

The optical unit may include: a first groove formed along a length direction of the unit module and recessed to be inclined in a direction from one edge of the bottom surface of the unit module; and a second groove extending from an end of the first groove and recessed to the other edge of the bottom surface of the unit module in a circular-arc shape. The top surface of the unit module may be inclined to be biased in a direction opposite to a direction of inclination of the first groove, and the unit module may be arranged and connected in parallel in the plurality of row or column directions.

The optical unit may further include connection members which extend from the edges of outermost unit modules, respectively, among the plurality of unit modules arranged and connected in parallel along the plurality of row or column directions, and are coupled to the housing.

The optical unit may further include: a first groove formed along a length direction of the unit module and recessed to be inclined in a direction from one edge of the bottom surface of the unit module; a second groove extending from an end of the first groove and recessed to the other edge of the bottom surface of the unit module in a circular arc shape; and at least one indication portion formed in the connection member and configured to indicate a direction facing the first groove.

The optical unit may further include connection members which extend from edges of outermost unit modules, respectively, among the plurality of unit modules arranged and connected in parallel along the plurality of row or column directions, and are coupled to the housing.

The optical unit may further include a frame which is formed in a periphery of the plurality of unit modules arranged and connected in parallel along the plurality of row or column directions and is coupled to the housing.

The optical unit may further include coupling members which extend from the frame, and extend from edges of outermost unit modules among the plurality of unit modules and are coupled to the housing.

The optical unit may further include: connection members which extend from the frame, extend from edges of outermost unit modules among the plurality of unit modules, and are coupled to the housing; and at least one indication portion which is formed in the connection members and indicates a direction facing a direction of indication of the unit module.

The optical unit may further include a fourth surface formed in a circular arc shape along the surface of the unit module facing the semiconductor optical devices, and the unit modules may be arranged and connected in parallel in the plurality of row or column directions.

In addition, the term “semiconductor optical device” as used in claims and detailed description refers to an LED chip or the like that includes or uses optical semiconductor.

The “semiconductor optical device” may include a package-level device with various types of optical semiconductor as well as the above-mentioned LED chip.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional conceptual diagram illustrating an overall configuration of an optical semiconductor lighting apparatus according to an embodiment of the present invention.

FIG. 2 is a perspective view illustrating a structure of an optical unit, which is an essential component of the optical semiconductor lighting apparatus according to the embodiment of the present invention.

FIG. 3 is a perspective view illustrating an overall configuration of an optical semiconductor lighting apparatus according to another embodiment of the present invention.

### DETAILED DESCRIPTION OF THE ILLUSTRATED EMBODIMENTS

Exemplary embodiments of the present invention will be described below in detail with reference to the accompanying drawings. Throughout the disclosure, like reference numerals refer to like parts throughout the drawings and embodiments of the present invention.

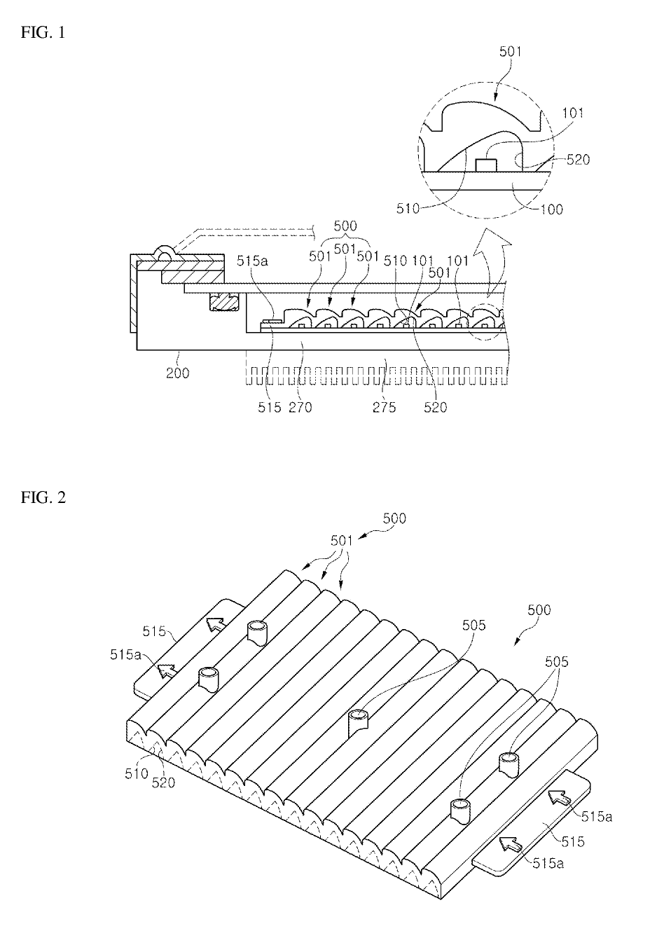

FIG. 1 is a cross-sectional conceptual diagram illustrating an overall configuration of an optical semiconductor lighting apparatus according to an embodiment of the present invention. FIG. 2 is a perspective view illustrating a structure of an optical unit, which is an essential component of the optical semiconductor lighting apparatus according to the embodiment of the present invention.

For reference, reference numeral 275 in FIG. 1 represents a heat sink, and reference numeral 505 in FIG. 2 represents a coupling tap, such as a bolt, which is coupled to a housing 200.

As illustrated in FIGS. 1 and 2, the optical semiconductor lighting apparatus according to the present invention may include a light emitting module 100, the housing 200, and an optical unit 500.

The light emitting module 100 includes semiconductor optical devices 101 arranged in a plurality of rows and columns, a circuit board, and a driving circuit (not illustrated) for driving the semiconductor optical devices 101.

The housing 200 includes a heat sink base 270 in which the light emitting module 100 is disposed, and provides a space in which components, such as the optical unit 500 to be describe below, is mounted.

The optical unit 500 is arranged in parallel along a plurality of row or column directions. The optical unit 500 changes a path of light emitted from the semiconductor optical devices 101 to a specific direction. The optical unit 500 enables the implementation of a small-sized and compact apparatus, and freely controls light distribution.

In this case, the optical unit 500 includes at least one unit module 501 in which the plurality of semiconductor optical devices 101 are arranged in a row or column direction and integrally formed so as to change the path of light emitted from the semiconductor optical devices 101.

In addition to the above-described embodiment, the following various embodiments can also be applied to the present invention.

The optical unit 500 is provided for allowing the implementation of the small-sized and compact apparatus and freely controlling light distribution, and includes the unit module 501 which is a type of lens for deflecting light emitted from the semiconductor optical devices 101 to a specific direction as illustrated in FIGS. 1 and 2.

In other words, the unit module 501 has a top surface convexly inclined to be biased toward one side in the row or column directions of the plurality of semiconductor optical devices 101, and a bottom surface concavely recessed and inclined to be biased toward a direction opposite to a direction of inclination of the top surface.

More specifically, the top surface of the unit module 501 is convexly inclined to be biased toward one side, and the bottom surface of the unit module 501 includes a first groove 510 and a second groove 520.

That is, the first groove 510 is formed along a length direction of the unit module 501, and is recessed to be inclined from one edge of the bottom surface of the unit module 501 in a direction.

The second groove 520 extends from an end of the first groove 510 to the other edge of the bottom surface of the unit module 501, and is recessed in a circular arc shape.

In this case, the top surface of the unit module 501 is convexly formed to be biased toward a direction opposite to the inclination direction of the first groove 510, so that the top surface of the unit module 501 is mutually asymmetric to the first groove 510 that is the bottom surface of the unit module 501.

Accordingly, a plurality of unit modules 501 are arranged in parallel along the plurality of row or column directions, and the optical unit 500 is provided with the plurality of unit modules 501 integrally formed.

Meanwhile, the optical unit 500 may further include coupling members 515 which extend from the edges of the outermost unit modules 501, respectively, among the plurality of unit modules 501 arranged and connected in parallel along the plurality of row or column directions, and are detachably coupled to the housing 200.

In this case, the optical unit 500 may further include at least one indication portion 515a which is formed in the coupling member 515 and indicates a direction facing the first groove 510.

In the case of deflecting the direction of light emitted from the semiconductor optical devices 101 to the specific direction, the indication portion 515a is used as an indicator for indicating a direction in which the optical unit 500 is coupled to the housing 200.

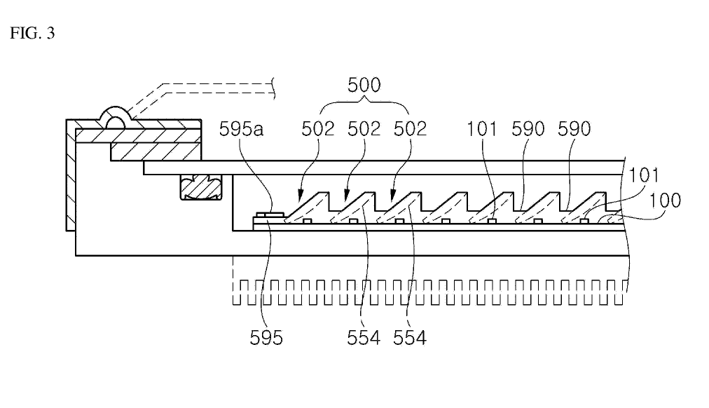

Meanwhile, the optical unit 500 may include a reflection-plate-type unit module 501 as illustrated in FIG. 3, instead of the lens-type unit module as illustrated in FIGS. 1 and 2, so that light emitted from the semiconductor optical devices 101 is deflected to a specific direction.

The unit module 502 faces one row or one column of among the semiconductor optical devices 101 arranged in the plurality of rows or columns, and is arranged to be inclined in one direction with respect to the light emitting module 100.

In this case, the unit modules 502 are arranged and connected in parallel along the plurality of row or column directions and are formed into one body.

In this case, the optical unit 500 may include a frame 590 so as to integrally form the plurality of unit modules 502.

The frame 590 is formed in the periphery of the plurality of unit modules 502 arranged and connected in parallel along the plurality of row or column directions, and is coupled to the housing 200.

In this case, the optical unit 500 may further include coupling members 595 which extend from the frame, and extend from the edges of the outermost unit modules 502 among the plurality of unit modules 502 and are coupled to the housing 200.

In this case, the optical unit 500 may further include at least one indication portion 595a for indicating a direction facing the direction of inclination of the unit module 502. Since the detailed shape of the indication portion 595a has been described above with reference to FIG. 2, a detailed description thereof will be omitted herein.

In addition, the optical unit 500 may further include a fourth surface 554 formed in a circular arc shape along the surface of the unit modules 502 facing the semiconductor optical devices 101, making it possible to more widely spread light emitted from the semiconductor optical devices 101 to a specific direction.

As described above, the basic technical spirit of the present invention is to provide the optical semiconductor lighting apparatus which can be implemented with a small-sized and compact structure and can freely control light distribution.

The above-described configurations according to the present invention can obtain the following effects.

First, the optical semiconductor lighting apparatus according to the present invention includes the optical unit for changing the path of light emitted from the plurality of semiconductor optical devices arranged in the plurality of rows or columns to a specific direction, so that a small-sized and compact apparatus can be implemented and light distribution can be freely controlled.

Specifically, the present invention can reduce the number of components mounted in the housing and implement the optical semiconductor lighting apparatus with a small-sized structure by integrating the plurality of unit modules arranged and connected in parallel.

In addition, the optical semiconductor lighting apparatus according to the present invention can be applied to not only a general lighting apparatus which uniformly spreads light emitted from the semiconductor optical devices, but also to a lighting apparatus, such as a wall-type canopy light, which enables light to be deflected in a specific direction, making it possible to provide a high-reliability product which can actively cope with various demands from users.

In particular, the present invention can provide excellent performance in backward area control and light distribution by using a cylinder-type unit module having an asymmetric structure, that is, by arranging a plurality of cylinder lens.

In addition, the present invention can selectively mount the unit module, such as a reflection plate inclined with respect to a light emitting module, to the housing in the rows or columns of asymmetric cylinder lenses, symmetric cylinder lenses, or semiconductor optical devices, making it possible to cope with various installation and construction environments.

While the embodiments of the present invention have been described with reference to the specific embodiments, it will be apparent to those skilled in the art that various changes and modifications may be made without departing from the spirit and scope of the invention as defined in the following claims.

What is claimed is:

1. An optical semiconductor lighting apparatus, comprising:
a light emitting module comprising semiconductor optical devices arranged in a plurality of rows and columns;
a housing comprising a heat sink base in which the light emitting module is disposed; and
an optical unit arranged in parallel along the plurality of row or column directions, and configured to change a path of light emitting from the semiconductor optical devices to a specific direction,
wherein the optical unit comprises at least one unit module integrally formed in the row or column directions of the semiconductor optical devices.

2. The optical semiconductor lighting apparatus of claim 1, wherein the unit module comprises:
a top surface convexly inclined to be biased toward one side in the column or column directions of the plurality of semiconductor optical devices; and
a bottom surface concavely recessed and inclined to be biased toward a direction opposite to a direction of inclination of the top surface.

3. The optical semiconductor lighting apparatus of claim 1, wherein the optical unit comprises:
a first groove formed along a length direction of the unit module and recessed to be inclined in a direction from one edge of the bottom surface of the unit module; and
a second groove extending from an end of the first groove and recessed to the other edge of the bottom surface of the unit module in a circular-arc shape,
wherein the top surface of the unit module is inclined to be biased in a direction opposite to a direction of inclination of the first groove, and
wherein the unit module is arranged and connected in parallel in the plurality of row or column directions.

4. The optical semiconductor lighting apparatus of claim 1, wherein the optical unit further comprises connection members which extend from the edges of outermost unit modules, respectively, among the plurality of unit modules arranged and connected in parallel along the plurality of row or column directions, and are coupled to the housing.

5. The optical semiconductor lighting apparatus of claim 4, wherein the optical unit further comprises:
a first groove formed along a length direction of the unit module and recessed to be inclined in a direction from one edge of the bottom surface of the unit module;
a second groove extending from an end of the first groove and recessed to the other edge of the bottom surface of the unit module in a circular arc shape; and
at least one indication portion formed in the connection member and configured to indicate a direction facing the first groove.

6. The optical semiconductor lighting apparatus of claim 1, wherein the optical unit further comprises connection members which extending from edges of outermost unit modules, respectively, among the plurality of unit modules arranged and connected in parallel along the plurality of row or column directions, and are coupled to the housing.

7. The optical semiconductor lighting apparatus of claim 1, wherein the optical unit further comprises a frame which is formed in a periphery of the plurality of unit modules arranged and connected in parallel along the plurality of row or column directions and is coupled to the housing.

8. The optical semiconductor lighting apparatus of claim 7, wherein the optical unit further comprises coupling members which extend from the frame, and extend from edges of outermost unit modules among the plurality of unit modules and are coupled to the housing.

9. The optical semiconductor lighting apparatus of claim 7, wherein the optical unit further comprises:
connection members which extend from the frame, extend from edges of outermost unit modules among the plurality of unit modules, and are coupled to the housing; and
at least one indication portion which is formed in the connection members and indicates a direction facing a direction of indication of the unit module.

10. The optical semiconductor lighting apparatus of claim 1, wherein,
the optical unit further comprises a fourth surface formed in a circular arc shape along the surface of the unit module facing the semiconductor optical devices, and
the unit modules are arranged and connected in parallel in the plurality of row or column directions.
